(19) United States
(12) Patent Application Publication
(10) Pub. No.: US 2006/0061541 A1
(43) Pub. Date: Mar. 23, 2006

(54) Flexible display device

(75) Inventors: Chi-Yuan Ou, Taipei (TW); Lee-Chung Lin, Taipei Hsien (TW)

Correspondence Address: BACON & THOMAS, PLLC, 625 SLATERS LANE, FOURTH FLOOR, ALEXANDRIA, VA, 22314, US

(73) Assignee: Smart Displayer Technology Co., Ltd., Taipei Hsien (TW)

(21) Appl. No.: 11/010,509

(22) Filed: Dec. 14, 2004

(30) Foreign Application Priority Data
Sep. 17, 2004 (TW) 093128118

(51) Int. Cl. G09G 3/34

(52) U.S. Cl. 345/107

(57) ABSTRACT

A flexible display device includes flexible display panel, a soft PCB (printed circuit board), and a control circuit that provides a micro-controller or a simple control logic circuit, a display driver and a battery. The display panel is an Electrophoretic Display (i.e. a Bistable Display) that has the super-thin and flexible characteristics in function and can easily fabricate into bent strip articles. These articles can combine with soft articles to make them further thinner and lighter, as well as portable to attain the functions of display effect and decoration.

### FIELD OF THE INVENTION

The invention relates to a flexible display device, and more particularly, relates to a flexible display panel with an electrophoretic display as display panel. The display panel is able to combine into the main body of a flexible display panel when it fabricates in a soft PCB (printed circuit board) that can attain the display function through the control of a control circuit.

### BACKGROUND OF THE INVENTION

Owing to the progress in technology, LCD (Liquid Crystal Display), such as LCTV (Liquid Crystal Television) and LC Monitor etc. has been gradually replacing the big and bulky CRT (Cathode-Ray Tube) prevailed in the past. Part of the reasons is that LCD is much lighter and thinner than CRT. Portable products of LCD such as Notebook computer, PDA (Personal Digital Assistant), Cellular Phone, electronic watch etc. have developed. However, since LCD is fragile because LCD employs glass as its substrate, the product design for making relatively lighter and thinner LCD runs across a bottleneck. In consequence, when it comes to product design, LCD needs not only to strengthen its structure but also to reinforce its protection against cracking, particularly, the application of dressing-type products have become the mainstream in the new generation. However, it is a pity that the current display device is unable to combine with them pertinently so as to proceed to the step of satisfying the various requirements of the technologically progressive society of today. Take the electronic wristwatch for example, in addition to a strap, an arbor for performing function, and a room for containing a circuit device and a power source system etc. are required. The similar products that we can find in the market are rather heavy and bulky. Moreover, the variation of their design is not that much, at most, trying to make an issue of adding a control IC (integrated circuit) for having a time-counting function to make a simple functional variation while the type of outward appearance still looks bulky. This kind of products seems hardly to strive for being in fashion, let alone to capture the consumers' preference, especially, the preference of the large number of consumers in young generation, under the trend of elaborating “light, thin, short, and small” of today. Therefore, this kind of product is quite limited on its development, and can hardly to have a breakthrough.

The conventional CRT and LCD, being thick, heavy, and non-flexible in characteristics, are lacking of variation in utility. These are the disadvantage of the prior art.

### SUMMARY OF THE INVENTION

In view of the above-mentioned disadvantages of the prior arts, the invention provides a flexible display device making use of the electrophoretic display to combines the flexible PCB (printed circuit board) that aims to ameliorate at least some of the disadvantages of the prior art or to provide a useful alternative. Since the invention is apt to fabricate into bent strip or belt shape as well as soft articles, it can combines with the daily necessities to make them light, thin, and portable. Therefore, the invention not only can accomplish a certain kind of display effect and decorative function but also can overcome the pity that the conventional CRT and LCD are not able to combine with the soft articles.

Therefore, in order to compensate the above-mentioned imperfection of the prior art, one of the objectives of the invention is to provide a display device, particularly a flexible display panel that mainly makes use of an electrophoretic display, i.e. a bistable display, to fabricate on a flexible PCB and to combine into a main body of a flexible display panel to accomplish the display objective by making use of the control of a control circuit.

It is another objective of the invention to provide a flexible display panel to accomplish a certain display effect and decorative function since the invention is apt to fabricate into bent strip or belt shape as well as soft articles, it can combines with the daily necessities to make them light, thin, and portable.

To achieve the above-mentioned objectives, the invention provides a flexible display device that includes a flexible display panel, a soft PCB, and a control circuit that provides a micro-controller or a simple control logic circuit, a display driver and a battery. The display panel is an Electrophoretic Display (i.e. a Bistable Display) that has the super-thin and flexible characteristics in function and can easily fabricate into bent strip articles. These articles can combine with soft articles to make them further thinner and lighter, as well as portable to attain the functions of display effect and decoration.

Detailed description as well as the content of the techniques that relate to the invention accompanied by the drawings is described in the following:

### BRIEF DESCRIPTION OF THE DRAWINGS

FIG. 1 is a schematic diagram of the main body of the invention.

FIG. 2 is a circuit-design block diagram of the control circuit of the invention.

FIG. 3 is a circuit-design block diagram of another control circuit of the invention.

FIG. 4 is a schematic diagram of the outer appearance of the embodiment of the invention.

FIG. 5 is a schematic diagram of another outer appearance of the embodiment of the invention.

FIG. 6 is a schematic diagram of one other outer appearance of the embodiment of the invention.

FIG. 7 is a circuit-design block diagram of the control circuit of the embodiment of the invention.

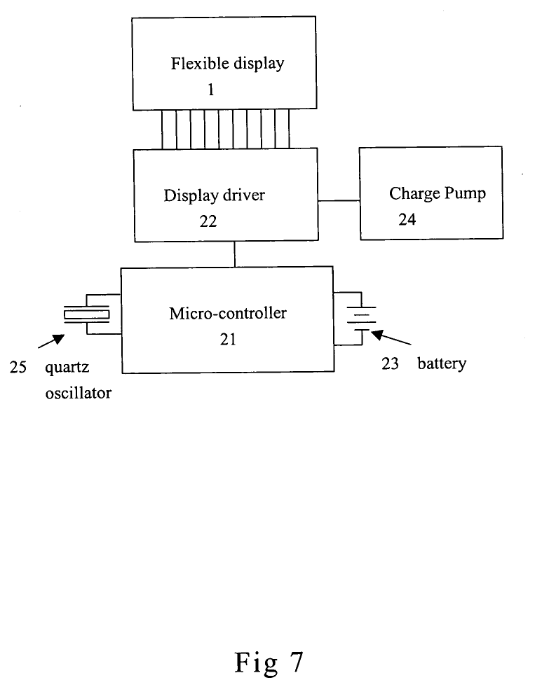

### DETAILED DESCRIPTION OF THE EMBODIMENTS

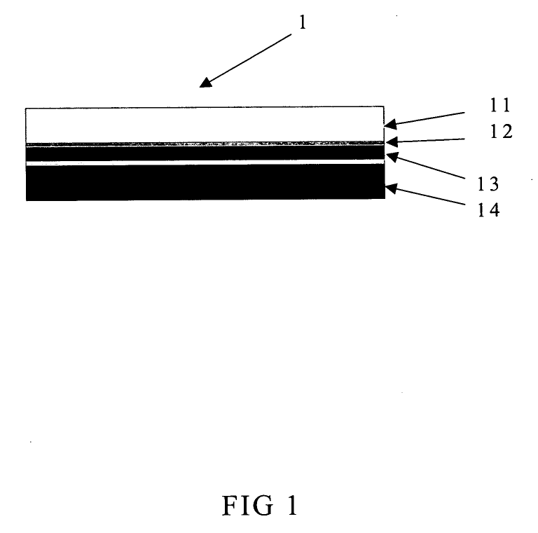

As shown in FIG. 1, the laminated main body (1) of the invention includes a top layer of transparent soft plastic material (PET) (11), a second layer of electrically conductive Indium oxide (ITO) (12), a third layer of electrophoretic display (13), and a bottom layer of soft PCB (14).

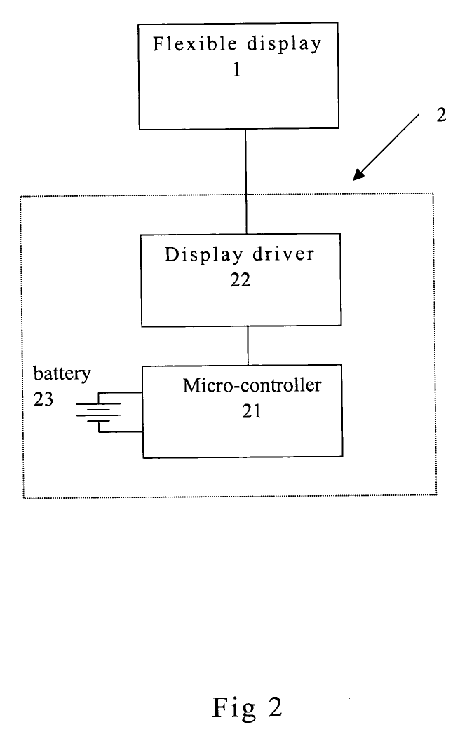

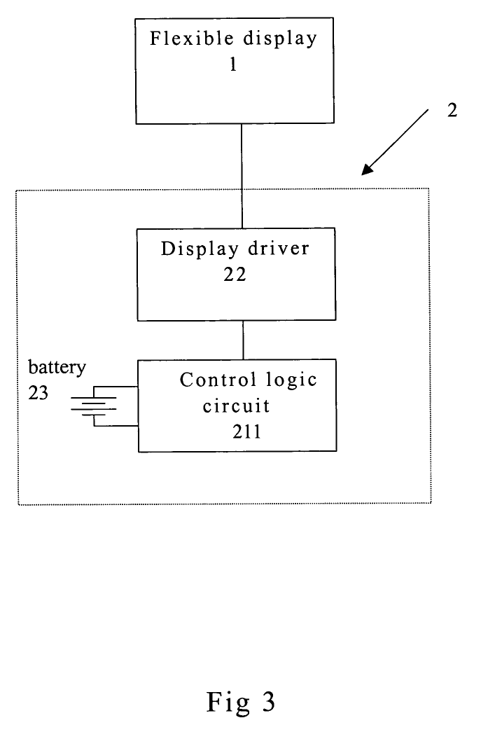

As shown in FIG. 1 and FIG. 2, provided externally is a display driving control circuit (2) connected to the bottom layer of the soft PCB (14). The control circuit (2) provides a micro-controller (21) or a simple control logic circuit (211) (see FIG. 3), a display driver (22), and a battery (23). The battery (23) provides power (battery is changeable) required to control the electrodes of the electrically conductive ITO (12) and soft PCB (14). In this way, the electrodes between the two substrates generate positive and negative voltage difference to make the electrophoretic display material (13) change color in accordance with its voltage variation, thus to attain the objective of display.

In the above-mentioned structure of electrophoretic display and soft PCB, the transparent soft plastic material (11) has a thickness within 0.15 mm, and the thickness of the electroplate layer is negligible since it is very small. Moreover, the thickness of the electrophoretic display material (13) is around 25 μm (micro meter), and the thickness of the soft PCB (14) can be within 0.1 mm, thereby, the result can generate a flexible display panel under 0.26 mm of thickness.

Since the flexible display device of the invention is apt to fabricate into bent strip or belt shape as well as soft articles, it can be applied in super-thin products, especially, it can combine with the daily necessities with strip and belt shape as well as soft in characteristic to make them light, thin, and portable. Therefore, the invention can accomplish a certain kind of display effect and decorative function. Besides, since the pattern content displayed by the flexible display panel is generated by the use of designing and storing on the soft PCB, the pattern content on the soft PCB can be changed in accordance with various applications and utilities. In this way, it makes the invention more versatile that it makes their application products attract more consumers' preference.

What is more, in order to bring the effect of the invention into full play, such as to make its displayed pattern possess the function or effect of luminous marking or flicker, all one has to do is to provide a luminous marking device and connect it to the control circuit to generate the luminous effect. One can also add a design with flicker function on the control circuit to generate flickering effect, and of course, one can make use of a design of control circuit to control the time and way of flickering. In addition, if one needs to make the invention possesses the functions of displaying time, temperature etc., all one has to do is to add a quartz oscillator or a temperature sensor and connect them to the control circuit. Therefore, it is understood that the versatility of the applicable range of the invention is that the invention can attain the effect of various requirements by making use of the combination of the peripheral facilities or devices. Furthermore, to make the products of the invention appear more beautiful or having decorative function, one can have the other decorated articles pasted or stuck to them, or have the products of the invention pasted or stuck to the other decorated article. In this way, the products of the invention can attain the effect of more practical, beautiful, and decorative, thereby, more attractive for consumers' preference.

The following description bases on the fact that the invention possesses the function and effect of displaying time and pattern.

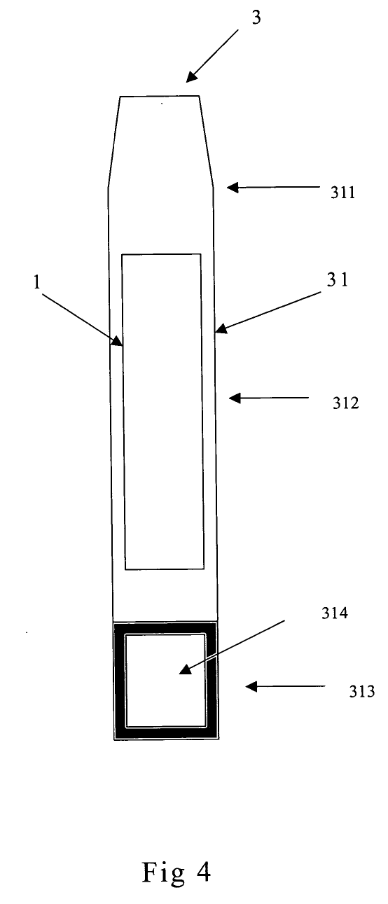

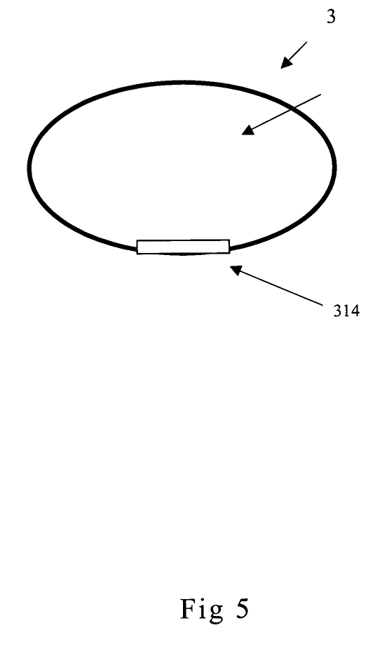

As shown in FIG. 4, the main body (1) of a flexible display panel of the invention is stuck to a belt-shape article (e.g. a watchband) to become a combined article (3). This combined article (3) can be divided into three parts, that is, an upper part (311), a lower part (313), and a display area (312) formed by the main body (1) of the flexible display panel. The lower end of the lower part (313) has a buckled-up end (314) while the upper part (311) possesses two kinds of function: 1. It can buckle up or stick to the buckled-up end (314) of the lower end of the lower part (313) in order to fix the combined article (3) in place; 2. It can contain the control circuit (2) and the battery (23), and to fix thereat. FIG. 5 shows the appearance after buckling up that includes the combined article (3) and the buckled-up end (314).

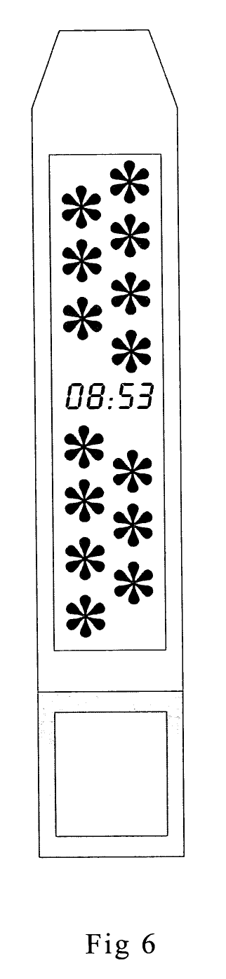

The display device structure employed in the above-mentioned embodiment is exactly the flexible display panel of the invention wherein the displayed pattern content is generated by designing and storing in the soft PCB. One can changes the displayed pattern contents in accordance with various objectives and utilities in their application. For example, as shown in FIG. 6, one can set up the center spot of the displayed area as a time or a digital display spot for displaying time and digit while one can also set up the upper and lower spots of the displayed area as pattern spots depending on various requirements. The content of pattern can be cartoon, caricature, people, animal etc. (the pattern embodiment shown in FIG. 6 is flower petals). One can further control these patterns by use of the control circuit to make these patterns generate various flickering effects to accomplish a certain display effect and decorating function. In this way, one can have more vivid combined articles for attracting consumers, thereby, to promote one's business opportunities.

Furthermore, the portion of control circuit in this embodiment includes a main body (1) of the flexible display panel of the invention, a display driver (22), a micro-controller (21), a charge-pump (24), a battery (23), and a quartz oscillator (25). One can divide the frequency of the quartz oscillator (25) by use of the micro-controller (21) to gain ½ frequency, then the micro-controller (21) performs the calculation to obtain data such as second, minute, and hour etc., thereafter, transfer these data into display code and transmit them to display driver (25). In the meantime, the charge-pump (24) transmits the voltage required by the display driver (25) to drive the flexible display device of the invention.

In addition, one can also add some push-button in the above-mentioned embodiment as functional buttons for changing time or numerical set-up, or add some input/output peripheral interfaces such as temperature sensor for displaying the temperature on the display panel.

In accordance with the above-mentioned statements, one can define or design the function, or the content, or the area, or the location intending to display, or the article intending to combine with in accordance with consumers' preference without any limitation. Therefore, the range of application of the invention is rather wide, consequently, it can enhance the strength of competitiveness of the combined articles in the market

It will become apparent that for those people skilled in the art can make various modifications and variations that can be made to the structure of the invention without departing from the scope or spirit of the invention. In view of the foregoing, it is intended that all the modification and variation fall within the scope of the following appended claims and their equivalents.

What is claimed is:

1. A flexible display device, comprising:
A main body combining a electrophoretic display and a soft PCB, including a top layer composed of a transparent soft plastic material, a second layer having an electroplating a conductive Indium oxide (ITO), a third layer of electrophoretic display material, and a bottom layer of soft PCB; and
A control circuit, having a micro-controller, a display driver, and a battery;
wherein, the battery provides power required to control the electrodes of the electrically conductive ITO and soft PCB such that the electrodes between the two substrates generate positive and negative voltage difference to make the electrophoretic display material change color in accordance with its voltage variation, thus to attain the objective of display.

2. The flexible display device of claim 1, wherein the control circuit further comprises a simple control logic circuit, a display driver, and a battery.

3. The flexible display device of claim 1, wherein the electrophoretic display is a display panel having the function of bistable state.

4. The flexible display device of claim 1, wherein the flexible display device can combine with a bent strip or belt shape and soft articles of the daily necessities to accomplish display effect and decorative function.

5. The flexible display device of claim 1, wherein the pattern content displayed by the flexible display panel is generated by the use of designing and storing on the soft PCB, and the pattern content on the soft PCB can be changed in accordance with various applications and utilities.

6. The flexible display device of claim 1, wherein the pattern stored in the soft PCB can accomplish flickering effect by making use of a design of the control circuit, and one can control the way and time of flickering also by making use of a design of control circuit.

7. The flexible display device of claim 1, wherein one can add an input/output peripheral interface to the control circuit to make the invention become a temperature display device.

8. The flexible display device of claim 1, wherein when combining the micro-controller, the display driver, charge-pump, battery, and quartz oscillator to be the control circuit, one can make the invention become a display device possessing the function of time counting.

9. The flexible display device of claim 7, wherein one can add at least one push-button to the control circuit as functional buttons for changing time or number.
